(19) United States
(12) Patent Application Publication
(10) Pub. No.: US 2005/0228629 A1
(43) Pub. Date: Oct. 13, 2005

(54) Method and a processor for parallel processing of logic event simulation

(75) Inventor: Damian Dalton, County Dublin (IE)

Correspondence Address: BIRCH STEWART KOLASCH & BIRCH, PO BOX 747, FALLS CHURCH, VA, 22040-0747, US

(73) Assignee: Neosera Systems Limited, Dublin (IL)

(21) Appl. No.: 10/505,260

(22) PCT Filed: Feb. 22, 2002
(86) PCT No.: PCT/IS02/00023

§ 371 Date: Oct. 20, 2004

(51) Int. Cl. G06F 17/50

(52) U.S. Cl. 703/16

(57) ABSTRACT

A method and a processor for parallel processing of logic event simulation on circuits comprising a polarity of logic gates, the logic gates having interconnect lines therebetween, the processor (1) further comprising a main processor (2) and an associative memory mechanism (3), the associative memory mechanism (3) comprising a plurality of associative arrays (5, 6) and at least one result register, and there is provided accessible external memory (4) in which a circuit representation may be stored and divided into a plurality of segments, each of the segments having a segment identifier, which in turn has segment data associated therewith. The segment identifier and segment data being stored in a segment table (14) in the associative memory mechanism. Each of the segments may then be brought into the associative memory mechanism (3) for evaluation one at a time. There is additionally provided an amended result registering mechanism (8) to allow numerous tests and gate pairs to be carried out and recorded.

This invention relates to a processor for parallel processing of logic event simulation and a parallel processing method of logic event simulation on circuits comprising a plurality of logic gates, the logic gates having interconnect lines therebetween, the method being carried out in a main processor and an Associative Memory Mechanism, the Associative Memory Mechanism comprising a plurality of associative arrays and at least one result register.

One of the problems encountered in the field of parallel processing has been achieving significant speed up figures commensurate to the additional processing power available for simulation. There have been many different approaches to solving this problem including the use of compiled code and event driven simulation in which a circuit is partitioned amongst processors. In compiled code simulation all gates are evaluated at all time steps even if they are not active. The circuit has to be levellised and only unit or zero delay models can be employed. This compiled code mechanism has been applied to several generations of specialised parallel hardware accelerators designed by IBM as well as the Yorktown simulation engine and the engineering verification engine (EVE). Although impressive speed of figures for the methods have been reported, they are often misleading as gates that are not active or being evaluated as well and therefore the actual processing power is only a fraction of that reported.

Another approach taken is that described by Soule and Blank in: Parallel Logic Simulation on General Purpose Machines (Proc Design Automation Conf, June 1988, 166-171). However the intrinsic unit delay model of compiled code simulators is overly simplistic for many applications. Some delay model limitations of compiled code simulation have been eliminated in parallel event-driven techniques. These parallel algorithms are largely composed of two phases, a gate evaluation phase and an event-scheduling phase The gate evaluation phase identifies gates that are changing and the scheduling phase puts the gates affected by these changes (the fan-out gates) into a time-ordered linked schedule list, determined by the current time and the delays of the active gates. However, overall performance has been disappointing and usually speed of figures ranging from 3 to 5 have been achieved.

Various optimising strategies such as load balancing, circuit partitioning and distributed queues are used to realise the best speedup figures. Unfortunately, these mechanisms themselves contribute large overhead communication costs for even modest sized parallel systems. This leads to a reduction in the speed of figures and a rather complex system. Furthermore, the gate evaluation process incurs between 10 and 250 machine cycles per gate evaluation, which is time consuming and costly to the processing capability of the machine.

All of these approaches claim to achieve more significant speed-up figures than was previously attainable. However, both of these approaches were still found to be insufficient to warrant the increase in the amount of additional processing power provided for the gain in speed-up times achieved.

This led to a parallel processing method of logic event simulation incorporating an associative memory mechanism as described in the Applicants own PCT Patent Application No. WO 01/01298. In WO 01/01298 the Applicant describes using a parallel processing method of logic event simulation with an associative memory mechanism in which the history of values on a particular line may be stored as a bit sequence and gate evaluations may be carried out on these bit sequences in both hardware and software resulting in superior speed up figures for parallel processing.

There were however a number of problems with the parallel processing method of logic event simulation using an associative memory mechanism. The main problem with the approach taken in WO 01/01298 was that the size of circuit to be evaluated was limited by the size of the associative memory mechanism associative arrays. Typically, this would limit the capacity of the associative arrays to a few thousand logic gates, which prevented practical large scale use of the invention. By simply increasing the size of the associative arrays the design became unwieldy and difficult to manage.

Conventional Cache Memory Mechanisms were heretofore unsuitable for use with such a method of parallel processing of logic event simulation. Conventional Cache, Memory Mechanisms deal on a geographical based system, known as the principle of locality of reference and a probabilistic based system of data retrieval. Usually there is a probability as high as 90% or more that the correct memory block is brought in but this would not be acceptable in the associative memory mechanism provided. Such a system also wastes valuable processing time when a reference is made to a particular block that has not been brought in from external memory at the appropriate time. A more accurate Cache system was necessary for the parallel processing method of logic event simulation that was heretofore available.

Another difficulty experienced by the Applicants was that the number of tests that could be carried out on gates pairs in the associative arrays was limited by the number of bits per word in the Group-Result Register Bank (GRRB). This prevented very extensive testing of a circuit being carried out in a single sequence and instead testing had to be carried out in a number of discrete stages. In addition to the above it was further discovered that valuable processing time was being taken up in the evaluation of the interconnect lines thereby putting further demands on the processing time of the parallel processor. Also, there was no way of modelling synchronous devices as they were to complex to manage in the known parallel processing method of logic event simulation.

All of these meant that although a significant advance had been made over the prior art in achieving speed up figures for the parallel processing method the device was still impractical for everyday application.

The object of the present invention is to provide a parallel processing method of logic event simulation and a processor to carry out the method that overcomes at least some of these difficulties and to provide an improved parallel processing method of logic event simulation.

### STATEMENTS OF INVENTION

According to the invention there is provided a parallel processing method of logic event simulation on circuits comprising a plurality of logic gates, the logic gates having interconnect lines therebetween, the method being carried out in a main processor and an associative memory mechanism, the associative memory mechanism comprising a plurality of associative arrays and at least one result register, characterised in that:—
there is provided an external memory and means to transfer data between the associative memory and the external memory, the method comprising the steps of:
storing a circuit representation in external memory;
dividing the circuit representation into a plurality of circuit segments;
assigning a unique segment identifier to each segment; generating a circuit segment table in the associative memory and storing the unique segment identifiers along with segment data in a circuit segment table;
for each time period, identifying segments that may be active in that time period based on the segment data stored in the circuit segment table; and
bringing active segments into the associative memory mechanism from external memory for evaluation.

By storing the circuit representation in external memory and dividing the circuit up into a plurality of segments, the segments may be brought into the associative memory mechanism one at a time as required. In this way only potentially active segments need to be brought into the associative memory mechanism (AMM) during any one-time interval. This means that circuits of potentially any size may be evaluated using the method shown. In addition to this, by using the associative memory mechanism to store the circuit segment table, tests and evaluations on the circuit segment data may be carried out in a quick and efficient manner as well as utilizing all available storage space. Another advantage of using what could be described as a cache-like system is that unlike conventional cache memory mechanisms which are based on a probabilistic and geographical based system for determining memory block retrieval, the present method extracts segments from memory in the knowledge that these blocks are potentially active and must be evaluated in a particular time segment. This means that time is not wasted by the processor retrieving segments from memory only after it has been alarmed that a particular block was missing as there is certainty as to whether a block must be brought in from memory or not.

In another embodiment of the invention there is provided a parallel processing method of logic event simulation in which the segment data stored in the circuit segment table comprises the maximum delay state of a segment, which indicates the maximum time delay in which any gate in that segment may make a transition. By storing the maximum delay state of a segment the processor will be aware that a particular segment must be brought in for evaluation each time until the maximum delay state is in a state where no changes to gate outputs will occur or until there is a change to an input to that segment. This also prevents segments that are inactive from being brought in for evaluation each time unit and therefore optimizes the processing time of the processor.

In one embodiment there is provided a parallel processing method of logic event simulation in which the associative memory mechanism comprises a pair of associative arrays, associative array 1a and associative array 1b, an input value register bank and a hit list. This is seen as a simple and manageable layout for the associative memory mechanism.

In one embodiment of the invention there is provided a parallel processing method of logic event simulation in which the circuit segment table data of associative array 1a, associative array 1b and input value register bank are stored in external memory during segment evaluation. By storing the circuit segment table in external memory the total memory utilised may be optimised. In this way the full associative memory mechanism may be used for gate evaluations, as the segment table is stored externally while segments are being evaluated.

In one embodiment there is provided a parallel processing method of logic event simulation in which after evaluation of a segment the segment data of all its' fan-out gates are updated. When a segment is evaluated it may have fan out gates in a separate segment. These fan out gates may then affect the segment data in their own segments. A check is made to update each segment of a fan-out gate to ensure that the segment data is up to date. Previously inactive segments may become active and by updating the segment data of fan out gates the segment data remains correct.

In another embodiment of the invention there is provided a parallel processing method of logic event simulation in which when a new maximum delay state is greater than the previous maximum delay state of a fan-out segment, the segment data is updated with the new maximum delay state. This ensures that a potentially active segment will be brought in for evaluation at all times. Updates to segment data is captured by the method.

In a further still embodiment of the invention there is provided a parallel processing method of logic event simulation in which inactive segments are not brought into the associative memory mechanism for evaluation until they have undergone an input change to a gate in that segment. This minimises the pressures on the processing time of the processor. Previous systems in other known architectures waste significant time and hence reduce the speed up figures by spending valuable processing time on evaluation of dormant gates. The method shown avoids this by only evaluating potentially active gates.

In a further embodiment of the invention there is provided a parallel processing method of logic event simulation in which all interconnect lines are held in a segment dedicated to interconnect lines. As interconnect lines are a passive entity and do not need to undergo evaluation, significant saving in processing time may be saved rather than constantly evaluating these interconnect lines.

In another embodiment of the invention there is provided a parallel processing method of logic event simulation in which all logic gates of a particular type are held in segments with logic gates of the same type. This is seen as beneficial as only tests pertinent to the gate type need be applied thus further speeding up the processing time taken by the method.

In one embodiment of the invention there is provided a parallel processing method of logic event simulation in which the segment table is an Nₛ×M bits segment table where Nₛ is equal to the number of segments and M is equal to the sum of the number of bits wide of associative array 1a, associative array 1b, input value register and the hit list. The combined widths of array 1a, array 1b, input value register and hit list are sufficient to store the segment table in a compact and manageable format. Sufficient space is provided to store all necessary information concerning each segment.

In one embodiment of the invention there is shown a parallel processing method of logic event simulation in which at least portion of associative array 1a, associative array 1b, input value register bank and the hit list are used to store the segment table at all times. This is seen as beneficial as the segment table will remain in the associative array at all times and time is not wasted in writing the data in the segment table to and retrieving the data from external memory. In another embodiment still of the invention there is provided a parallel processing method of logic event simulation in which when gate evaluations are completed for a particular time interval the previous segment table history is stored in the associative array 1b. By having the previous segment table stored here it is also accessible for further testing to be carried out on the segment data. Previous segment table may be easily compared with current segment table to ascertain changes in the individual segment's segment data and to provide analytical data.

In a further embodiment of the invention there is provided a parallel processing method of logic event simulation in which the input value register bank is shifted into associative array 1b, and associative array 1a contains the maximum state of each segment, test patterns are then applied to contents of array 1b to determine transitions to lower states. The segment data of the current segment table may be compared with previous segment table data to check the transitions to lower states. This may mean that a state has transitioned to an inactive state where no evaluations are necessary or simply a lower state where further evaluations will have to be carried out.

In one embodiment of the invention there is shown a parallel processing method of logic event in which segments in the state Sₒ are brought in for evaluation. Any segment reaching this state must be brought in for evaluation as it is the final state which any gate in a segment may change. This may then change to an inactive state such as S_{TERM} once the evaluation has taken place.

In one embodiment of the invention there is shown a parallel processing method of logic event simulation in which the minimum state of all segments, S_{STATEMIN}, is calculated and all states are time advanced by S_{STATEMIN} Time Units before evaluation of the segments commences. This is seen as particularly beneficial as if no states are actually undergoing any changes in that interval then all segments may be time advanced by the minimum delay state of all the segments. This effectively skips the simulation to the next point in time in which any gates may undergo change and therefore prevents time being wasted in waiting for the lowest segment state to decrease to state Sₒ. Significant savings to simulation time may be made using this method.

In a further embodiment of the invention there is provided a parallel processing method of logic event simulation in which the set up time, T_{SETUP}, of synchronous devices may be modelled where Tₛₑₜᵤₚ=N.p+M, where N=integer, M=integer<P and P=bit width of array 1b, where by the following steps:—
the state entry of array 1a of this signal is set to Sₛₙ;
a start marker is placed in the left most position of array 1b;
array 1b is incremented in time in the normal manner and when the start marker reaches the right-most position of array 1b and the signal has remained constant, the state Sₛₙ is decremented to Sₛₙ₋₁, and the next time array 1b is incremented the start marker is returned to the left-most position in array 1b once again and array 1b is then incremented in the normal manner;
the previous step is repeated until state entry Sₛₓ=Sₛₒ, then the array 1b is incremented another M times; and
if the signal has remained constant for N.p+M time units then the state entry in array 1a is set to state setup, S_{SETUP}.

By using this method, synchronous devices may be modeled using the processor with access to external memory. This allows for many more devices to be simulated accurately than was possible before. This is partially due to the provision of the associative memory mechanism, which allows for the modeling to be carried out in a simple and efficient manner.

In another embodiment still of the invention there is provided a parallel processing of logic event in which the hold time, T_{HOLD}, of synchronous devices may modeled where T_{hold}=R.p+Q, and where R=integer, Q=integer<P and P=bit width of array 1b using the following steps:
when a clock makes a transition there is a search of state entries in array 1a to see if any input signals are in state Sₛₑₜᵤₚ;
states in Sₛₑₜᵤₚ are updated to the state S_{HR}, and a start marker is placed in the left-most position of array 1b, array 1b is incremented in the normal manner and until the marker has made its way to the right-most position in array 1b and the signal has remained constant;
the state is decremented to S_{HR-1}, the start marker is returned to the left-most position in array 1b the next time that array 1b is incremented, array 1b is then incremented in the normal manner and this is continued until the state is equal to S_{Ho};
when S_{HR}=S_{HO} then the array 1b is incremented a further Q times;
if signals remain constant over the entire period then the signal state is updated to S_{HOLD} and the output value of the device is ascertained.

These synchronous devices may now be accurately modeled and included in any simulation of a circuit carried out. It is achieved in a simple and efficient manner with a minimum cost in processing time. The method will easily determine whether the hold time conditions of a synchronous device have been satisfied and whether those conditions were satisfied during a clock transition to cause a change in the output of the device.

In one embodiment of the invention there is provided a parallel processing method of logic event simulation in which if the output value of the device has changed it is propagated to the fan-out list of the device. This will again ensure that the processor remains up to date and any segment data of fan out gates will also be updated if necessary.

In one embodiment of the invention there is shown a parallel processing method of logic event simulation in which successive states are generated by causing a shift right operation in array 1a. A simple parallel shift right operation is simple to carry out and is not taking on processor time. Furthermore, it is a reliable way of transitioning through the successive states of a device.

In one embodiment of the invention there is shown a parallel processing method of logic event simulation in which there is provided an amended result registering mechanism in which when a number of tests are carried out on a gate pair the result of each test is sent to a result register where on completion of all the tests the result register will indicate that all tests were successful or that at least one was unsuccessful. This method will greatly increase the number of tests that may be carried out on a gate pair. Previously, this was limited to the number of bits in the group result register bank. Tests on bit sequences could then be carried out to see if all tests were successful. Now, all the individual running the simulation will know is whether or not all the tests were successful or whether at least one test was failed.

This is particularly useful as hundreds of tests may now be carried out sequentially, allowing the more thorough testing to be applied and therefore ultimately greater reliability of the circuit being tested may be achieved.

In one embodiment of the invention there is provided a parallel processing method of logic event simulation in which the result register comprises an adder. This will allow the tester to check the total number of tests against the successful number of tests in a simple manner. It will be readily apparent if any tests have been failed. Alternatively, the result register may be a bi-state device, preferably the result register will be a D-flip-flop. By having either a bi-state device or a D-flip-flop, the previous results and the present result could be combined in the device whereby if both tests were successful the output of the register would give an appropriate signal that the tests were successful. However, if one test was unsuccessful this would be reflected by the output of the bi-state device or D-flip-flop that would indicate an unsuccessful test. The output of the bi-state device or D-flip-flop would remain indicating that a test had been failed until all the tests were completed. This allows the simulation to incorporate many more tests than was previously possible.

In another embodiment of the invention there is shown a parallel processing method of logic event simulation in which the result register on start-up is supplied with an appropriate priming input instead of last result so that it is ready to receive the first result. In some instances the result register may need to be primed with a priming input to ensure that if the first test is successful it is recorded as such.

In a further still embodiment of the invention there is provided a parallel processing method of logic event simulation in which the amended result registering mechanism further comprises a result polarity circuit to invert a result and ensure a logic 1 is applied to the result register if the correct response to a test was for the test to be failed. There may be particular tests carried out on gate pairs in which it will be desirable for the test to have been failed. This is, of course, in fact a successful test and should be recorded as such by the result register. By having a result polarity circuit it is possible to carry out tests that are to be either successful or failed, which allows further flexibility when carrying out testing.

In one embodiment of the invention there is provided a parallel processing method of logic event simulation in which the result polarity circuit comprises a pair of AND gates, a pair of inverters and an OR gate, a result polarity control is fed to each of the AND gates, the other input of each of the AND gates being provided by the result of a test carried out on a gate pair, the inverters inverting the two inputs to one of the AND gates, the outputs of the AND gates being fed directly to the OR gate. This is seen as a particularly simple structure that is both simple and efficient as well as being both space and cost efficient for the circuitry involved.

In another embodiment of the invention there is provided a parallel processing method of logic event simulation in which the amended result registering mechanism is further provided with a logic combination circuit to determine whether an output gate pair of array 1b are ANDed or ORed together. Again by having a logic combination circuit the type of test carried out on gate pairs can be achieved simply and quickly The gate pairs may be toggled between an AND operation and an OR operation with a minimum of fuss.

In one embodiment of the invention there is provided a parallel processing method of logic event simulation in which the logic combination circuit further comprises three AND gates and a logic combination circuit control, the logic combination circuit control being ANDed individually with each output of an array 1b gate pair and the gate pair ANDed in the third AND gate, when the logic combination requires an AND operation to be carried out, logic combination circuit control is given a value 0 and if an OR operation is required logic combination circuit control is given a logic value 1. This is seen as a particularly useful implementation of the logic combination circuitry as it has very few gates and therefore will be both space and cost efficient as well as being inexpensive to provide. In addition to the above the logic combination circuit may include an OR gate, each of the outputs of the three AND gates being fed to the OR gate. This groups the three results in a simple and efficient manner and results in a single line being used for the onward transmission to further circuitry. In one embodiment the output of the OR gate is led to the result polarity circuit as the result of a test carried out on a gate pair.

In another of the invention there is provided a parallel processing method of logic event simulation in which there is provided an amended result registering mechanism for each gate pair. This will provide less delays in the circuitry and although further circuitry is necessary, in fact less circuitry than was necessary before having a result register for each gate pair was possible. In this way, the results of each gate pair can be checked individually.

In a preferred embodiment of the invention there is provided a parallel processing method of logic event simulation in which when all active segments have a state>S0, a check of all segment states is made until the lowest segment state S_{MIN} is found, then each segment state is decremented by S_{MIN} in order to advance simulation to the next evaluation state. This minimizes the time that the processor remains inactive by advancing the segment with the minimum state to the state at which it must be evaluated. This eliminates gate evaluation over time periods when there is no gate activity. This optimizes the processing speed up times further achieved by the method.

In another preferred embodiment of the invention there is provided a parallel processing method of logic event simulation in which the lowest state value is stored in a low global register and each time there is a gate state change if the new state is less than the low global state register value the low global register state value is replaced by the new state. This keeps a constant measure on the minimum state of all the segments so that the processor does not spend time evaluating gates during inactive time periods.

In another embodiment of the invention there is provided parallel a processing method of logic event simulation in which there is provided a scan system comprising a priority decoder and a shift register. This provides an efficient way of noting any results in the processor and is furthermore a cost efficient and satisfactory way of detecting these results.

In one embodiment of the invention there is provided a parallel processing method of logic event simulation as claimed in any preceding claim in which there is provided a segment address table and the segment address table is divided into a number of rows, each row being M bits long, and each segment address is stored in the most significant M-D bits of the segment row when the number of segments=2^{D}.

In another embodiment still of the invention there is provided a processor for parallel processing of logic event simulation on circuits comprising a plurality of logic gates, the logic gates having interconnect lines therebetween, the processor further comprising a main processor and an associative memory mechanism, the associative memory mechanism comprising a plurality of associative arrays and at least one result register, characterized in that: —
there is provided accessible external memory for storage of a circuit representation;
means to divide the circuit representation into a plurality of circuit segments;
means to allocate a circuit segment identifier to each circuit segment, each circuit segment identifier having circuit segment data associated therewith;
the associative memory mechanism comprising a segment table for storage of segment identifiers and segment data;
means to identify active segments in any one time interval based on the segment data; and
means to retrieve those active segments from external memory for evaluation by the associative memory mechanism.

By having a processor for parallel processing with an associative memory mechanism such as this the circuit may be divided into several different segments and each segment may be brought in to the associative memory mechanism for evaluation when required. Only potentially active segments need to be brought in at any time interval, this improves the speed of figures achieved by the processor. The processor will furthermore have less processing demands on it.

In one embodiment of the invention there is provided a processor in which the segment data further comprises the maximum time delay for a gate in that segment to undergo a transition. By having the maximum delay as part of the segment data the processor will be able to determine which segments must be brought in for evaluation and when they must be brought in from external memory.

In one of the invention there is provided a processor in which the Associative Memory Mechanism further comprises a pair of associative arrays (1a and 1b), an input value register and a hit list. This is seen as a particularly efficient structure for the associative memory mechanism.

In another embodiment of the invention there is provided a processor in which cache data of associative array 1a, associative array 1b and input value Register Bank are stored in external memory during evaluation. By storing this data in external memory during evaluation the Associative Memory Mechanism is freed up to carry out evaluations on the segments.

In a further embodiment of the invention there is provided a processor in which after evaluation of the segment data the segments fan-out lists are updated. By updating the fan out lists of a segment the segment data is kept up to date. Each segment undergoing a transition may affect the maximum delay time or other data of another segment and this is noted subsequent to each evaluation.

In a further still embodiment of the invention there is provided a processor in which all interconnect lines are held in a segment dedicated to interconnect lines. As interconnect lines are passive elements they do not require evaluation as they do not undergo transitions in the same way that logic gates do. Therefore, they do not have to be brought in to the processor for evaluation. By grouping all of the interconnect lines in the same segment the processor will not have to carry out evaluations on this segment and therefore the processor's actual processing time is optimised.

In another embodiment still of the invention there is provided a processor in which all Logic gates of a particular type are held in a segments with logic gates of the same type. This is seen as advantageous as similar tests may be carried out on gates of the same type in the one segment. This further increases the speed-up figures of the processor.

In one embodiment of the invention there is provided a processor in which the segment table is an Nₛ×M bit segment table where Nₛ is equal to the number of segments and M is equal to the sum of all the number of bits width of associative array 1a, associative array 1b, input value register and the hit list. The associative array 1a, associative array 1b, input value register and hit list have been found to be sufficient to hold the segment table in a compact and manageable form.

In one embodiment of the invention there is provided a processor in which the set up time, T_{SETUP} of synchronous devices may be modeled and in which T_{SETUP}=N.p+M, where N is equal to an integer, M is equal to an integer<P, and P is equal to the bit width of array 1b, in which:
the state entry in array 1a of this signal is set to S_{SN};
a start marker is placed in the left-most position of array 1b;
array 1b is incremented in the normal manner and when the start marker reaches the right-most position of array 1b and the signal has remained constant, the state S_{SN} is decremented to S_{SN-1}, and the next time array 1b is incremented the start marker is returned to the left-most position in array 1b once again and the array 1b is then incremented in the normal manner;
the previous step is repeated until state entry=S_{S0}, then the array 1b is incremented another M times; and
if the signal has remained constant for N.p+M time units then the state entry in array 1a is set to state setup, S_{SETUP}.

This allows the processor to handle synchronous devices in a simple and efficient manner that was here-to-for thought impossible. Modeling of these devices now enables a wider range of circuits to be modeled.

In one embodiment of the invention there is provided a processor in which the hold time, T_{HOLD}, of synchronous devices may be modelled where T_{HOLD}=R.p+Q, and where R is an integer, 0 is an integer<P and P is equal to the bit width of array 1b, in which:—
when a clock makes a transition there is a search of state entries in array 1a to see if any input signals are in state S_{SETUP};
states in S_{SETUP} are updated to the state S_{HR}, and a start marker is placed in the left most position of array 1b, array 1b is incremented in the normal manner until the start marker has made its way to the right-most position in array 1b and the input signal has remained constant;
the state is decremented to S_{HR-1} and the next time array 1b is incremented start marker is returned to the left-most position in array 1b, array 1b is then incremented in the normal manner and this is continued until the state is equal to S_{H0};
when S_{HR} equals S_{H0} then the array 1b is incremented a further Q times;
if signals remain constant over the entire period then the signal state is updated to S_{HOLD} and the output value of the device is ascertained.

This will allow for synchronous devices to be modeled accurately further broadening the application of the processor. This processor can determine whether the conditions for transition have been met and whether the device has satisfied all the criteria for it to change in an efficient manner.

In one embodiment of the invention there is provided a processor in which if the output value has changed, it is propagated to the fan-out list of the device. This will keep the fan out gates of the synchronous device and the associated segments of the fan-out lists up to date with accurate information.

In another still embodiment of the invention there is provided a processor in which there is provided an amended result registering mechanism in which when a number of tests are carried out on the gate pair the result of each test is sent to a result register where on completion of all the test the result register output will indicate that all tests are successful or that at least one test was unsuccessful. By having an amended result registering mechanism an unlimited number of tests may be carried out on the gate pair being evaluated. Before now, this number was limited which meant that the reliability of the device could only be guaranteed by a certain amount as a limited number of evaluations on each gate pair could be carried out sequentially. Now, a much more thorough testing processor is provided.

In one embodiment of the invention there is provided a processor in which the result register comprises an adder. Alternatively, it may be provided by a processor in which the result register is a bi-state device or a processor in which the result register comprises a D-flip flop. Any of these devices will indicate whether or not all of the tests were successful or not which is sufficient for the testers needs. Additionally, the adder may be used to determine how many of the tests were unsuccessful.

In another embodiment of the invention there is provided a processor in which the result register on start-up is supplied with an appropriate priming input instead of last result so that it is ready to receive the first actual result. It may be necessary on start up to provide a priming input, particularly in the case of the D-flip-flop to ensure the correct result is output from the device in the event that the first test is successful.

In a further embodiment of the invention there is provided a processor in which the amended result registering mechanism further comprises a result polarity circuit to invert a result and ensure logic 1 is applied to the result register if the correct response to a test was that a particular test on a gate pair was to be failed. In certain circumstances it may be required that a particular test on a gate pair is actually failed. This though, is in fact, the desired result and therefore a successful test. It is therefore necessary to invert the result of the gate pair test before it is applied to the result register. This is achieved by using the result polarity circuit.

In a further embodiment of the invention there is shown a processor in which the amended result register mechanism is further provided with a logic combination circuit to determine whether an output gate pair of array 1b are ANDed or ORed together. This is beneficial as different tests may be applied to the gate pairs as required by the individual determining which tests must be carried out. The person carrying out the test may chose to carry out AND or OR operations.

In one embodiment of the invention there is provided a processor in which logic combination circuit further comprises three AND gates and a logic combination circuit control, the logic circuit control being ANDed individually with each output of array 1b gate pair, and the gate pair ANDed in the third AND gate, when the logic combination requires an AND operation, logic combination circuit control is given a value 0 and when an OR operation is required logic combination circuit control is given a logic 1. This is a particularly simple implementation of the logic combination circuit and uses a very small number of gates to achieve its purpose.

In another embodiment of the invention there is provided a processor in which the logic combination circuit further comprises an OR gate, each of the outputs of the three and gates being fed to the OR gate. This is a convenient way of grouping each of the outputs for onward transmission to additional circuitry. Furthermore it is a simple and space efficient way of carrying out the invention.

In one embodiment of the invention there is provided a processor in which the output of the OR gate is led to the result polarity circuit. In this way the result of tests carried out on gate pairs may be inverted if required. The result is then ready for onward transmission to the result register.

In one embodiment of the invention there is provided a processor in which when all active segments have a state>S0, a check of all segment states is made until the lowest segment state Sₘᵢₙ is found, then each segment state is decremented by Sₘᵢₙ in order to advance simulation to the next evaluation stage. By incorporating this feature the processor will not have to be evaluated over time periods of inactivity for a lengthy period of time and the speed of the processing will be enhanced further.

In another embodiment of the invention there is shown a processor in which the lowest state value is stored on a low global register and each time there is a gate state change if the new state is less than the low global state register value it replaces the low global state register value. In this way the processor is kept up to date and a constant monitoring of the minimum segment state is carried out to minimize time wastage.

In a further embodiment of the invention there is provided a processor in which there is provided a scan system comprising a priority decoder and a shift register. This scan system will the processor to detect whether any ‘hits’ have occurred in a quick and simple manner. This will further increase the speed of the processor.

In another embodiment of the invention there is provided a processor in which there is provided an amended result registering mechanism for each gate pair. This will obviate queuing delays in the processor and even though a circuit is required for each gate pair even less components are required now than were needed before.

In a further embodiment of the invention there is provided a processor in which there is provided a segment address table, the segment address table is divided into a number of rows, each row being M bits long, and each segment address is stored in the most significant M-D bits of the segment row when the number of segments is equal to 2^{D}. This is a simple and efficient way of addressing the segments in a uniform manner.

In one embodiment of the invention there is provided a processor in which the processor is embodied in computer readable format. Of course, the actual design of the processor may be in computer readable format such as compiled code or assembled code. Indeed it will often be much easier to run simulations on the processor in this form. When the processor is in this computer readable format it may be stored on a record medium such as a disc or a CD-ROM, DVD or any other similar record medium. Indeed the computer readable format may be stored on a carrier wave signal such as a radio wave of other such transmissible wave. The computer readable format may be transmitted over the Internet by such means. Indeed, when the carrier wave is being transmitted it may be by way of an optical carrier in which case the fibre-optic cables could be considered to be the carrier.

### DETAILED DESCRIPTION OF THE INVENTION

The invention will now be more clearly understood from the following description of some embodiments thereof given by way of example only with reference to the accompanying drawings in which:—

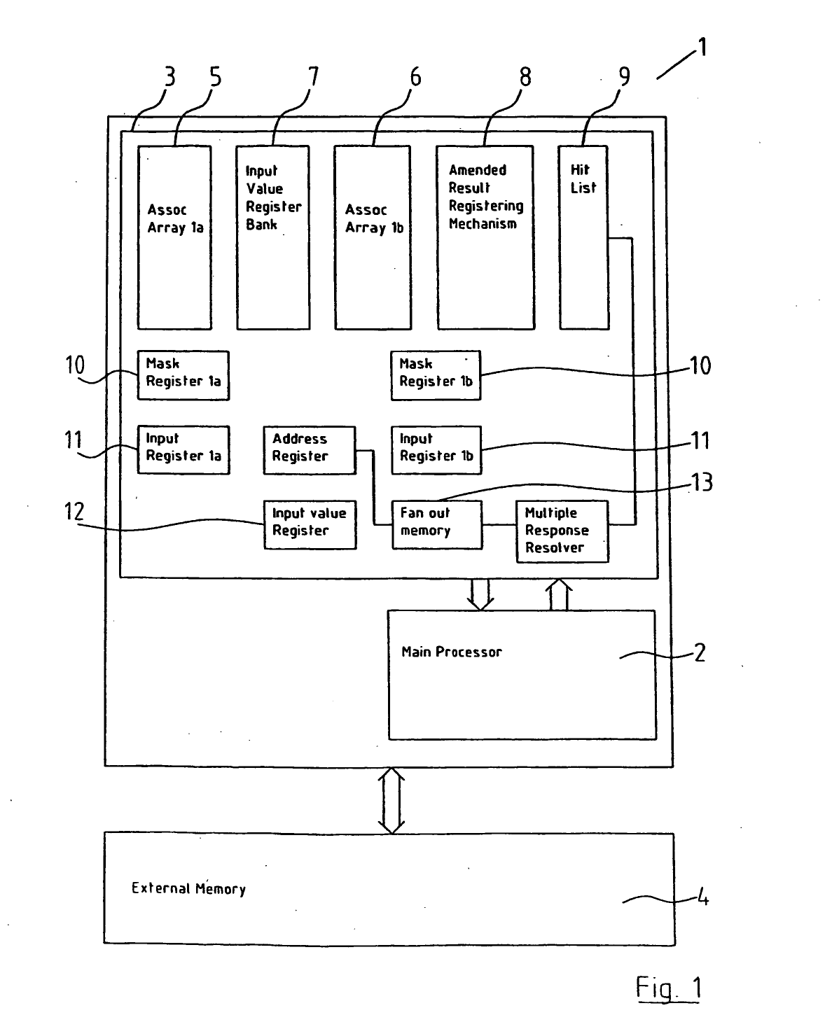

FIG. 1 is a block diagram of a processor for parallel processing of logic event simulation;

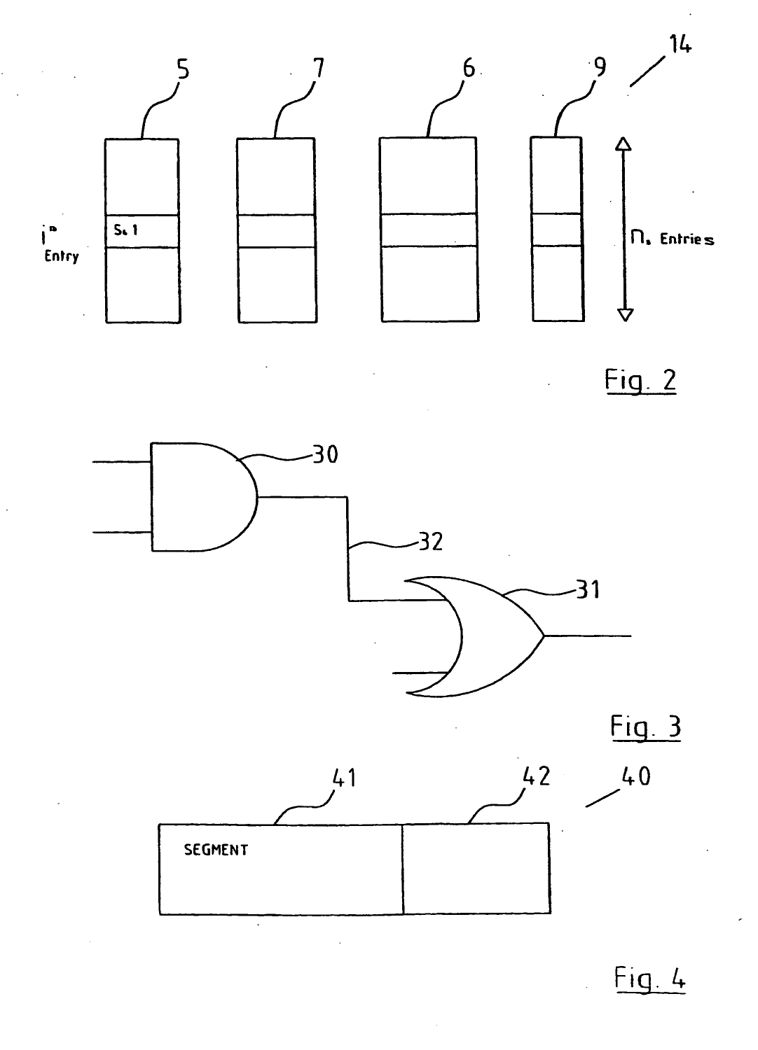

FIG. 2 is a block diagram of the segment table;

FIG. 3 illustrates a pair of logic gates, one of which being the fan-out gate of the other;

FIG. 4 illustrates the incorporation of segment addresses in fan-out addresses;

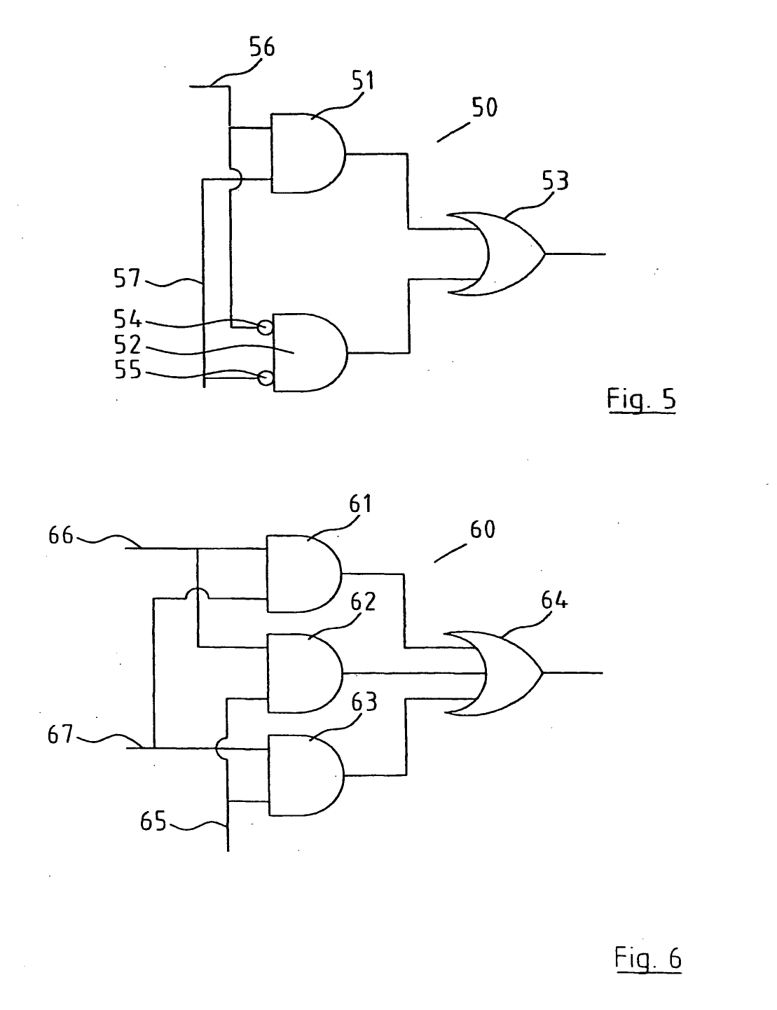

FIG. 5 is a logic gate representation of the result polarity circuit;

FIG. 6 is a logic gate representation of the logic combination circuit;

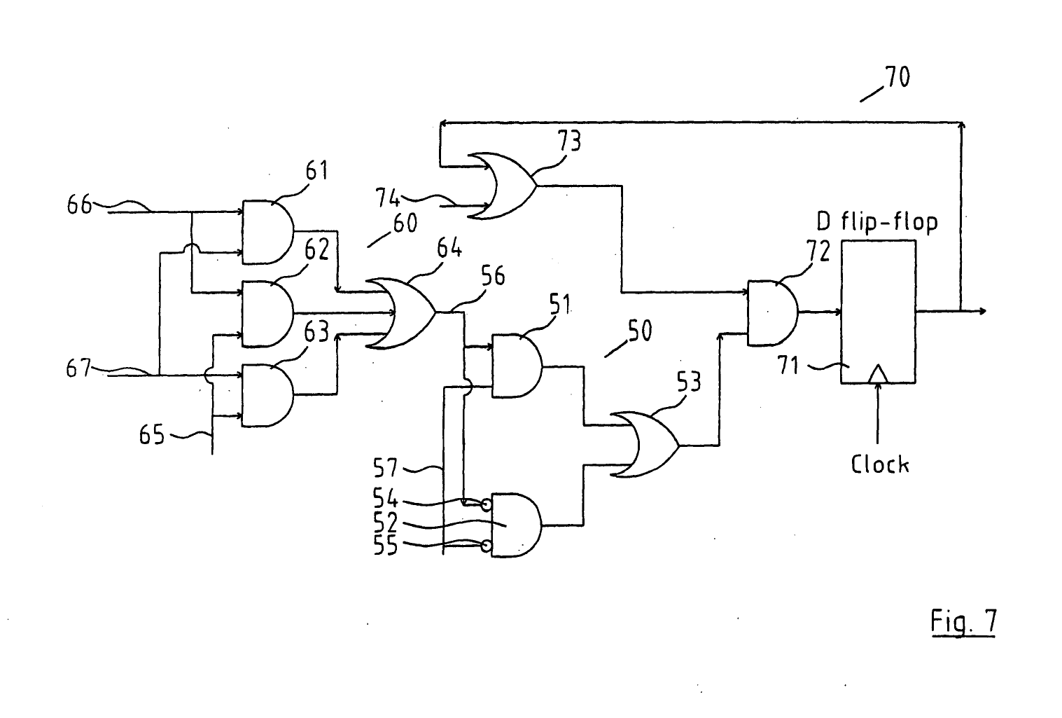

FIG. 7 is a logic gate representation of the amended result registering mechanism;

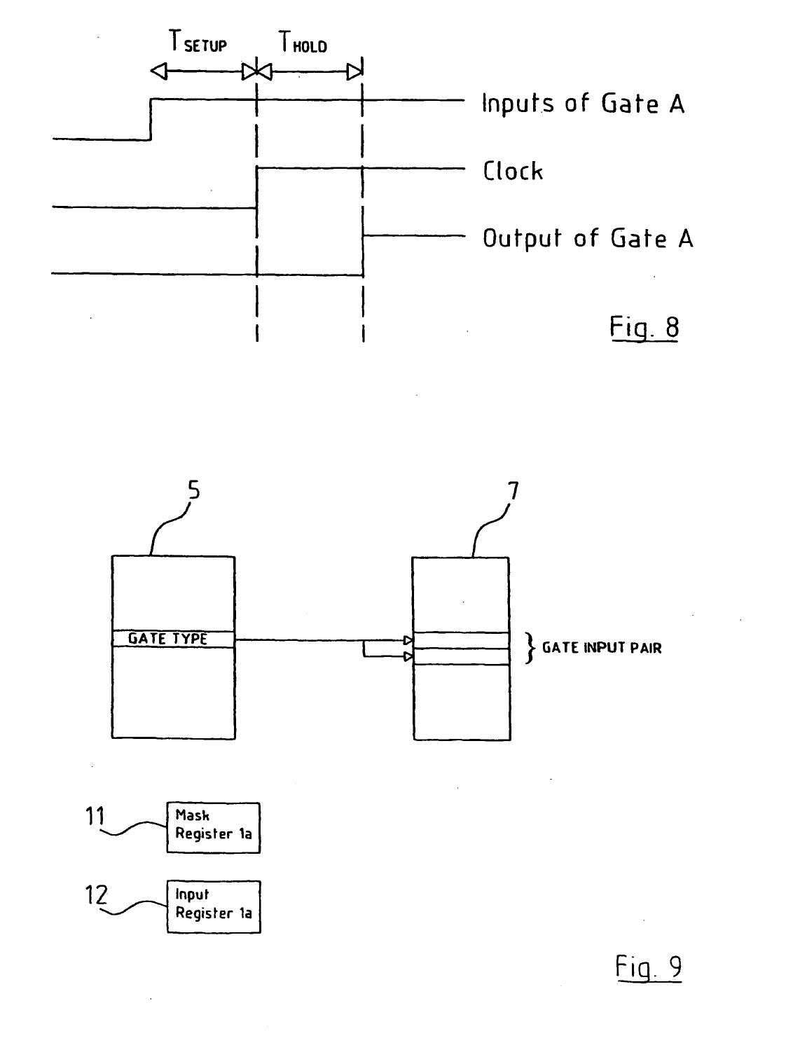

FIG. 8 is a timing diagram showing the set-up and hold times of a synchronous device;

FIG. 9 is a block diagram of a gate input addressing technique; and

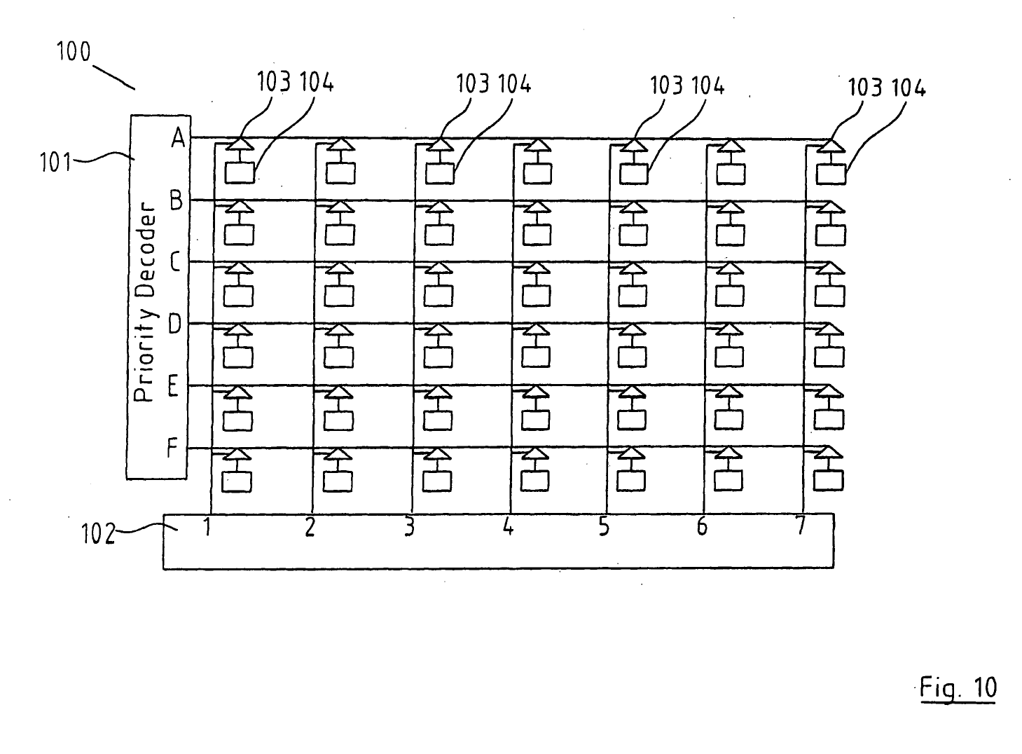

FIG. 10 is a block diagram of a scan system for use in the processor for parallel processing of logic event simulation.

Before describing the invention in detail it is thought useful to have a brief description of parallel processing of logic event simulation incorporating an associative memory mechanism. In using this technique, the processing of the logic simulation may be carried out faster than in other known topographies by hard-wiring many of the calculation steps carried out by the processor. Signals on a line are represented as a bit sequence in logic. In its simplest form i.e. using two-state logic where a single bit is used to represent the signal on a line, a line will either have the binary value 1 or 0.1 for high and 0 for low. Obviously two, three or even more bits may be used to represent the signal value on a line.

These signal values may then be stored in the associative memory mechanism in word form in, for instance, associative array 1b. If two-state logic is being used and associative array 1b is 32 bits wide, then the current value of the signal on the line as well as the previous 31 values of the signal on that particular line may be stored in array 1b. Tests may then be carried out on these bit sequences to determine whether a particular gate went through a transition or not. Checks may be made to see if all tests that were carried out were successful or whether or not a test was failed whilst processing a particular circuit.

Referring now to the drawings and initially to FIGS. 1 and 2 thereof there is shown a processor for parallel processing of logic event simulation indicated generally by the reference numeral 1, comprising a main processor 2 and an associative memory mechanism 3. There is further provided accessible memory 4 for access by the main processor 2 and associative memory mechanism 3.

The associative memory mechanism 3 further comprises a pair of associative arrays, associative array 1a, 5, and associative array 1b, 6, an input value register bank 7, amended result registering mechanism 8 and a hit list 9. Each of the associative arrays 5, 6, is provided with a mask register 10 and input register 11. Input value register bank 7 is also provided with an input value register 12. There is additionally provided a fan-out memory 13 to monitor updates to fan-out gates (not shown).

Means to divide a circuit representation (not shown) are provided to divide the circuit representation into a plurality of circuit segments and there are means to allocate a circuit segment identifier (not shown) to each circuit segment. Each circuit segment identifier has circuit segment data associated therewith. The associative memory mechanism 3 comprises a segment table 14 for storage of segment identifiers and segment data and means to identify active segments (not shown) based on the segment data and means to retrieve those active segments (not shown) from external memory for evaluation.

In use, a circuit representation is stored in external memory 4. This circuit representation is divided up into a number of circuit segments, each circuit segment is given a circuit segment identifier with circuit segment data associated therewith. The circuit segment data is stored in the segment table 14 and in any one time interval a check of the segment table is carried out to determine whether any segments are active in that time period. These active segments are brought in from external memory for evaluation in the associative memory mechanism 3. Any segment not in state S_{TERM} or S_{HOLD} is a potentially active segment and is brought in for evaluation by the associative memory mechanism. Once a segment has been evaluated the segment data and segment data of any fan-out gates of the gates in the original segment are updated accordingly.

Referring now specifically to FIG. 2, it can be seen from the drawing that the segment table 14 is stored in the associative array 1a, 5, associative array 1b, 6, input value register bank 7 and hit list 9. In total there may be N entries in the segment table. The maximum state, S_{MAX}, which represents the maximum time delay of any gate in that segment is stored as part of the segment data in associative array 1a, 5. This determines whether or not a segment will be potentially active and whether it should be brought into the associative memory mechanism 3 from external memory 4. The max state may be updated each time the particular segment is brought in for evaluation or each time a fan-out gate in that segment has a current state greater than the maximum state.

Referring now to FIGS. 3 and 4 of the drawings, there is shown a typical scenario encountered in the processor for parallel processing of logic event simulation in which when a gate in a segment undergoes a transition, this transition must be propagated to the fan-out gates of that gate. These fan-out gates may be in another segment in which case the fan-out gates segment data may have to be updated accordingly. In FIG. 3 an AND gate 30 in one segment undergoes a transition in the current time interval. This AND gate is connected to its fan-out gate, in this case OR gate 31 by interconnect line 32. The fan-out address 40 (as shown in FIG. 4) of the OR gate 31 is divided into two parts, a segment address part 41 and a gate address part 42. The segment address part 41 contains the address of the particular segment in which the fan-out gate 31 is located and the gate address part identifies the actual fan-out gate 31 itself. The state value of the new signal propagated along the interconnect line 32 is determined and is compared with the maximum state of the identified segment. If the state value of the new signal is greater than the max state of the segment then the max state of the segment is updated accordingly.

Referring now to FIG. 5 of the drawings there is shown a result polarity circuit 5′, for the amended result registering mechanism 8. It may in some instances be desirable to have tests on a gate pair that are failed. In these instances the result actually represents a successful test. Therefore, depending on the result register (not shown) being used it may be necessary to represent successful tests with a logic 1 at all times. This is achieved by providing a result polarity circuit 50 that may invert the results of that test carried out on a gate pair in order to correctly indicate whether or not the test was successful.

The result polarity circuit comprises a pair of AND gates 51 and 52, an OR gate 53 and a pair of inverters 54 and 55. The result of a test from a gate pair is led along interconnect line 56 to AND gates 51 and 52. This result is passed through inverter 54 before reaching the input of AND gate 52. A result polarity control line 57 is in turn fed as input to each of the AND gates 51 and 52 respectively. The result polarity control line 57 is inverted before entering the AND gate 52. The outputs of the AND gates 51, 52 are fed directly to the OR gate 53 and from there onwards to the result register.

In use, if a test on a gate pair was to be successful, result polarity control line 57 is set to a logic value 1. If the test was successful then the output of AND gate 51 would also be a logic ‘1’ which would in turn be passed to OR gate 53 and onwards to the result register. If however, the test was unsuccessful the value of interconnect line 56 would be an 0 and both AND gates 51 and 52 would output logic 0, which would indicate to the OR gate and afterwards to the result register that a test had been failed.

If it is desirable that a test on a gate pair was to be failed then the result polarity control line is set to logic value 0. In this way, if the result of the test on a gate pair was failed a logic 0 would appear on interconnect line 56. The output of AND gate 51 would also therefore be a O, however, the inputs to AND gate 52 are both inverted before entering AND gate 52. Therefore, the output of AND gate 52 would be a logic 1. This would be propagated to OR gate 53 and onwards to the result register that the test was successful. It can be seen that if the desired result to the test was for it to be failed and it was in fact passed, giving a logic 1 on interconnect line 56, as the result polarity control line 57 was at logic “0” both of the AND gates 51 and 52 would output a 0, thereby indicating that the test was unsuccessful.

Referring now to FIG. 6 of the drawings there is shown a logic combination circuit 60. The logic combination circuit 60 comprises three AND gates 61, 62 and 63 respectively and an OR gate 64 fed from each of the outputs of AND gates 61, 62 and 63. There is additionally provided a logic combination circuit control 65.

Output 66 and 67 of a gate pair are led to AND gate 61. Output 66 is also led to AND gate 62 and output 67 is also led directly to AND gate 63. The logic circuit combination circuit control 65 is fed as a second input to both AND gates 62 and 63. In certain circumstances, a test to be carried out on the outputs 66, 67 of a gate pair may comprise an AND operation. In other circumstances the test to be carried-out on the outputs 66, 67 may be an OR operation. If the test to be carried out comprises an AND operation then logic combination circuit control 65 is set to logic value 0. Therefore, regardless of the values of outputs 66 and 67, the output of AND gates 62 and 63 will be zero. If both outputs 66 and 67 are a logic 1 then these are combined in AND gate 61 and the output of AND gate 61 and hence OR gate 64 will be a logic 1. If one of the output 66, 67 is a logic 0 then the output of AND gate 61 will also be zero and this is propagated to OR gate 64 indicating that the test was failed and the output of OR gate 64 is zero.

If the test requires an OR operation to be carried out on outputs 66, 67 then the logic combination circuit control. 65 is set to a logic value 1. Therefore if either output 66 or output 67 is a logic 1 then the output of AND gates 62 or 63 respectively will be a logic 1. Alternatively if both outputs 66 and 67 are logic 1 then the output of logic gate 64 is also a logic 1. Only if both outputs 66 and 67 are a logic 0 then AND gates 61, 62 and 63 will all register a logic 0 at their outputs and the output of gate 64 is zero.

Referring now to FIG. 7 of the drawings, where like parts have been given the same reference numerals as before, there is shown an amended result registering mechanism, indicated generally by the reference numeral 70. The amended result registering mechanism further comprises a logic combination circuit 60, a result polarity circuit 50 and a result register provided by D-flip-flop 71. The input of D-flip-flop 71 is provided by the output of the result polarity circuit logically ANDed with the last output of the D-flip-flop 71 in AND gate 72. In other words, the input of the D-flip-flop comprises the result of the current test on outputs 66, 67 of a gate pair logically ANDed with the result of the last test on outputs 66, 67 of the gate pair. On start up, the output of the D-flip-flop will be 0 so a priming input is applied to OR gate 73 on input priming line 74. The other input to OR gate 73 is from result of D-flip-flop i.e. last result. On start up, the input priming line 74 is set to a logic value 1 giving OR gate 73 an output of logic 1, which is supplied to AND gate 72 where it is combined with the result of the first test on the gate pair outputs. If the test on the gate pair was successful then a logic 1 will be supplied to the AND gate 72 from result polarity circuit 50 thereby giving AND gate an output of logic 1, which is given to the D-flip-flop as the result of the test The input priming line is then set to zero thereafter. If at any stage a test on the gate pair outputs 66, 67 is failed then the output of the AND gate will go to 0 and that result will be supplied to the D-flip-flop, which will in turn have a result 0. Due to the fact that previous result is ANDed with present result, the output of the D-flip-flop will remain at 0 thereafter and cannot change to logic 1 unless a new set of tests were started and input priming line was set to logic 1. Therefore, the individual testing the device will be able to see if any of the tests were failed as output of D-flip-flop will be logic 0 or if all the tests had been passed in which case output of D-flip-flop would equal 1. Theoretically, it is possible to apply an infinite number of tests to the outputs of a gate pair and see if all tests were successful or whether any were unsuccessful. It is envisaged that there will be an amended result registering mechanism for each gate output pair.

Referring now to FIG. 8 of the drawings there is illustrated the set up and hold timing diagram for a synchronous device. These devices include D-flip-flops, S—R flip-flops, J-K flip-flops and the like. These devices are triggered by the rising or falling edge of a clock signal. When triggered the output response of these devices is dependent upon the signal values on the inputs of these devices and in the case of the S—R Flip-Flop and the J-K Flip-Flop sometimes the output state of the device prior to the rising or falling edge determines the output response of the device after it is triggered. For edge triggered devices the output is only determinable if the input signals remain stable for a predefined time period before and after the active clock edge. These are defined as the Set-up and Hold times of the device.

In the processor the observance of these constraints can be validated. If we assume that each signal has a given Set-up and Hold time and that the length of the Set-up time is Tₛₑₜ₋ᵤₚ. Furthermore, assume that the time represented by the width of Array 1b is p and the length of Tₛₑₜ₋ᵤₚ is:
T_{set-Up}=Np+M.
Where N=Integer, M=Integer<p.

Assume the length of the Hold time is T_{hold}. Furthermore, assume that the time represented by the width of Array 1b is p and the length of T_{hold} is:
T_{hold}=Rp+Q.
Where R=Integer, Q=Integer<p.

The verification process that the input signal is held constant for a time period at least as long as Tₛₑₜ₋ᵤₚ can be implemented by initializing the State entry in Array 1a for this signal to state S_{SN} when a transition on this wire is detected. Simultaneously, a start marker is positioned into the leftmost location of the corresponding word in Array 1b. Array 1b is updated in the normal manner. When the start marker reaches the right-most position in Array 1b and the logic value of the signal has remained constant for all time units contained within Array 1b, the State of the signal in Array 1b is updated to state S_{SN-1}. This condition can be determined by applying the appropriate test pattern search to Array 1a and Array 1b.

This state amendment process is repeated until state Sₛₒ is attained. When in state Sₛₒ tests are made on Array 1b in the normal time incrementation process to determine when the input signal is stable for a further M time units. When this condition is fulfilled the signal is updated to Sₛₑₜ₋ᵤₚ. This state indicates that the Set-up conditions on the signal have been obeyed and the signal remains in this state until either the signal or the controlling clock makes an active transition. If the signal makes a transition the signal is put into state S_{SN} and the set-up validation procedure is repeated. However, if the clock makes a transition the signal enters the Hold validation process.

When the clock makes an active transition all input signals in state Sₛₑₜ₋ᵤₚ of a particular device type are identified in Array 1a through the parallel search mechanism of this array. These are put into state S_{HR}. Simultaneously, a start marker is positioned into the leftmost location of the corresponding word in Array 1b. Array 1b is updated in the normal manner. When the start marker reaches the right-most position in Array 1b and the logic value of the signal has remained constant for all time units contained within Array 1b, the state of the signal in Array 1b is updated to state S_{HR-1}. This condition can be determined by the applying the appropriate test pattern search to Array 1a and array 1b.

This state amendment process is repeated until state S_{HD} is attained. When in state S_{HO} tests are made on Array 1b in the normal time incrementation process to determine when the input signal is stable for a further Q time units. When this condition is fulfilled the signal is updated to S_{hold}. This state indicates that the Hold and Set-up conditions on the signal have been obeyed. If at any stage in the Hold validation process the signal makes a transition, the signal state reverts to State S_{SN}. Simultaneously as the signal state is updated to S_{Hold} the input signal values of the device are determined by appropriate tests to Array 1b in order to ascertain the output value of the device. If the output value has changed it is propagated to the fan-out list of the device.

The S_{Hold} state also indicates that the device has been evaluated and the fan-out updated. Successive states in these validation processes are generated through a shift right operation on the state binary representation. This is highly efficient as this can be accomplished in parallel in Array 1a on all relevant devices. States also have an encoding indicating the output value of the device prior to the current signal or clock transition.

When viewing the diagram shown in FIG. 8, it can be seen that the output of gate A will change once the set-up and Hold conditions have been satisfied for the device and the device has undergone a clock transition.

Referring now to FIG. 9 of the drawings there is shown a different way of addressing a gate pair in the input value register bank 7. Previously, two words in Associative Array 1a, 5, were used to address two input gate pair in the input value register bank. Now, for a gate input pair in which the logic gate being represented has equivalent inputs e.g. AND, OR, NAND or NOR gates, a single word in Array 1a, 5, may be used to activate two words in input value register bank 7.

Finally, FIG. 10 of the drawings is a block diagram of a scan system for use in the processor for parallel processing of logic event simulation. The scan system indicated generally by the reference numeral 100 is particularly useful in the processor having access to external memory as hits will be able to be detected in a much quicker and more efficient manner. This is of great benefit as the number of hits will increase proportionately with the size of the circuit being simulated. The scan system 100 further comprises a priority decoder 101, a shift register 102 and a plurality of tri-state buffers 103 and hit registers 104.

In use, in order to resolve hits in the hit registers 104 the shift register 102 first sets column 1 high. This enables tri-state buffers 103 in column 1. The hit status of column 1 is then visible to the priority decoder 101 through lines A to F. The priority decoder 101 searches for highs on these lines. It starts searching at A, and it has the ability to skip any non-high lines and is able to find successive hits in one clock cycle. When the search of lines A-F is finished column 1 is set low and column 2 of the shift register 102 is set high. The priority decoder 101 is then able to search through lines A to F in column 2. This is repeated until all columns have been searched. The address of a hit may be determined by the position of the high bit in the shift register and the position of the high bit in the priority decoder. At present, a 24 bit shift register with a 64 bit priority decoder has been found to be adequate as this allows 1,536 hit registers to be scanned.

Another important aspect of the invention is the ability of the processor to advance time in the simulation. At certain times during the simulation it may occur that there will be no activity in the processor. During these times the processor is not carrying out calculations and is effectively dormant until there is either some gate or device activity. By having the circuit divided into a number of segments the individual states of each of the segments may be monitored. The minimum state of all the segments, S_{MIN} may be stored in a dedicated register, low global register, if desired.

When the processor is going through a simulation period of no activity there is provided means to advance all segments by S_{MIN} states so that at least one segment is advanced in time to a state in which it must be evaluated by the processor. This ensures that the processor remains active for a greater percentage of time thereby enhancing the speed up figures of the processor. For instance, if we say that there are four segments in a circuit and the minimum state for each segment is as follows:
Segment 1, State-set ═{S6}
Segment 2, State-set={S4}
Segment 3, State-set={S9}
Segment 4, State-set={S6}

Segments are evaluated in state S0 and additionally in some cases fulfill a test pattern requirement on Array 1b. There will be no fan-out changes for any of the segments until the lowest state enters state S0. If we look at the set of states for each segment we can see that the lowest state initially is state S4. Therefore, all states must be decremented by S4 in order to bring this minimum state down to S0 and therefore bring the segment in for evaluation. Once each of the states has been decremented by S4 and segment 2 has been evaluated, the lowest remaining state is S2 in segments 1 and 3 respectively. All segments that are still potentially active are then decremented by S2, and segments 1 and 3 are, in turn, taken into the processor for evaluation. Once this has been achieved the remaining segment not in state S0 is segment 3. This is finally decremented by S3 and evaluated by the processor. Signal values in associative array 1b, 6, must also be adjusted to represent their amended values over this time period. This may be achieved by shifting the input value of each signal into all time positions of the corresponding word of associative array 1b. In this way, the processor having a number of segments, each segment having a plurality of logic gates and devices therein may have its potentially active segments time advanced to the next time in which a segment must be evaluated in order to avoid time wastage by the processor. Care must be taken not to confuse this with the maximum state being greater than S0.

When the maximum state in a segment is greater than S0 it will still have to be brought in for processing in the associative memory mechanism. Of course, it will be understood that the segments may contain the maximum number of gates that may be held in the associative memory mechanism. Alternatively, it may be advantageous to have less gates in particularly active segments, for instance half the total possible number of gates. Alternatively, it may be advantageous to group the segments so that gates that are active for similar amounts of time are grouped together. It is seen as preferable to group, interconnect lines into at least one segment on their own as they require no processing as they do not undergo evaluation and therefore need not take up valuable processing time.

In the example given the result register is shown as a D-flip-flop. Alternatively, this could be replaced an Adder in which the Adder could be incremented each time a test was successful and once all the tests have been completed the total of the Adder could be compared with the total number of tests carried out. In this way, the individual running the simulation would know whether all the tests have been successful or not. Alternatively, another bi-state device such as an AND gate could be used in isolation. The D-flip-flop is seen as preferable.

In some cases it may be desirable to keep the segment table in the associative memory mechanism at all times. This may increase processing requirements but will result in a faster processing system. This will result in the need for a larger associative memory mechanism but will obviate the need for time-consuming writes to and from external memory.

In this specification the terms comprise, comprises, comprised and comprising and any variation thereof as well as the terms include, includes, included and including and any variation thereof are deemed to be totally interchangeable and should be afforded the widest possible interpretation.

The invention is in no way limited to the embodiments here and before described but may be varied in both construction and detail within the scope of the claims.

1-65. (canceled)

66. A parallel processing method of logic event simulation on circuits comprising a plurality of logic gates, the logic gates having interconnect lines therebetween, the method being carried out in a main processor and an associative memory mechanism, the associative memory mechanism comprising a plurality of associative arrays and at least one result register, characterised in that:
there is provided an external memory and means to transfer data between the associative memory and the external memory, the method comprising the steps of:
storing a circuit representation in external memory;
dividing the circuit representation into a plurality of circuit segments;
assigning a unique segment identifier to each segment;
generating a circuit segment table in the associative memory and storing the unique segment identifiers along with segment data in a circuit segment table;
for each time period, identifying segments that may be active in that time period based on the segment data stored in the circuit segment table; and
bringing active segments into the associative memory mechanism from external memory for evaluation.

67. A parallel processing method of logic event simulation as claimed in claim 66 in which the segment data stored in the circuit segment table comprises the maximum delay state of a segment, which indicates the maximum time delay in which any gate in that segment may make a transition.

68. A parallel processing method of logic event simulation as claimed in claim 66 in which the associative memory mechanism comprises a pair of associative arrays, associative array 1a and associative array 1b, an input value register bank and a hit list.

69. A parallel processing method of logic event simulation as claimed in claim 68 in which the circuit segment table data of associative array 1a, and associative array 1b and input value register bank are stored in external memory during segment evaluation.

70. A parallel processing method of logic event simulation as claimed in claim 66 in which after evaluation of a segment the segment data of all its' fan-out gates are updated.

71. A parallel processing method of logic event simulation as claimed in claim 70 in which when a new maximum delay state is greater than the previous maximum delay state of a fan-out segment, the segment data is updated with the new maximum delay state.

72. A parallel processing method of logic event simulation as claimed in claim 66 in which inactive segments are not brought into the associative memory mechanism for evaluation until they have undergone an input change to a gate in that segment.

73. A parallel processing method of logic event simulation as claimed in claim 66 in which all interconnect lines are held in a segment dedicated to interconnect lines.

74. A parallel processing method of logic event simulation as claimed in claim 66 in which all logic gates of a particular type are held in segments with logic gates of the same type.

75. A parallel processing method of logic event simulation as claimed in claim 68 in which the segment table is an Nₛ×M bits segment table where Nₛ is equal to the number of segments and M is equal to the sum of the number of bits wide of associative array 1a, associative array 1b, input value register and the hit list.

76. A parallel processing method of logic event simulation as claimed in claim 68 in which at least portion of associative array 1a, associative array 1b, input value register bank and the hit list are used to store the segment table at all times.

77. A parallel processing method of logic event simulation as claimed in claim 68 in which when gate evaluations are completed for a particular time interval the previous segment table history is stored in the associative array 1b.

78. A parallel processing method of logic event simulation as claimed in claim 68 in which the input value register bank is shifted into associative array 1b, and associative array 1a contains the maximum state of each segment, test patterns are then applied to contents of array 1b to determine transitions to lower states.

79. A parallel processing method of logic event simulation as claimed in claim 66 in which segments in the state S_{O} are brought in for evaluation.

80. A parallel processing method of logic event simulation as claimed in claim 66 in which the minimum state of all segments, S_{STATEMIN}, is calculated and all states are time advanced by S_{STATEMIN} Time Units before evaluation of the segments commences.

81. A parallel processing method of logic event simulation as claimed in claim 68 in which the set up time, T_{SETUP}, of synchronous devices may be modelled where Tₛₑₜᵤₚ=N.p+M, where N=integer, M=integer<P and P=bit width of array 1b, where by the following steps:
the state entry of array 1a of this signal is set to Sₛₙ;
a start marker is placed in the left most position of array 1b;
array 1b is incremented in time in the normal manner and when start marker reaches the right-most position of array 1b and the signal has remained constant the state Sₛₙ is decremented to Sₛₙ₋₁, and the next time array 1b is incremented the start marker is returned to the left-most position in array 1b once again and array 1b is then incremented in the normal manner;
the previous step is repeated until state entry Sₛₙ=Sₛₒ, then the array 1b is incremented another M times; and
if the signal has remained constant for N.p+M time units then the state entry in array 1a is set to state setup, S_{SETUP}.

82. A parallel processing method of logic event simulation as claimed in claim 68 in which the hold time, T_{HOLD}, of synchronous devices may modelled where T_{hold}=R.p+Q, and where R=integer, Q=integer<P and P=bit width of array 1b using the following steps:
when a clock makes a transition there is a search of state entries in array 1a to see if any input signals are in state Sₛₑₜᵤₚ;
states in Sₛₑₜᵤₚ are updated to the state S_{HR}, and a start marker is placed in the left-most position of array 1b, array 1b is incremented in the normal manner and until the marker has made its way to the right-most position in array 1b and the signal has remained constant;
the state is decremented to S_{HR-1}, the start marker is returned to the left-most position in array 1b the next time that array 1b is incremented, array 1b is then incremented in the normal manner and this is continued until the state is equal to S_{Ho},;
when S_{HR}=S_{HO} then the array 1b is incremented a further Q times;
if signals remain constant over the entire period then the signal state is updated to S_{HOLD} and the output value of the device is ascertained.

83. A parallel processing method of logic event simulation as claimed in claim 82 in which if the output value of the device has changed it is propagated to the fan-out list of the device.

84. A parallel processing method of logic event simulation as claimed in claim 81 in which successive states are generated by causing a shift right operation in array 1a.

85. A parallel processing method of logic event simulation as claimed in claim 66 in which there is provided an amended result registering mechanism in which when a number of tests are carried out on a gate pair the result of each test is sent to a result register where on completion of all the tests the result register will indicate that all tests were successful or that at least one was unsuccessful.

86. A parallel processing method of logic event simulation as claimed in claim 85 in which the result register comprises an adder.

87. A parallel processing method of logic event simulation as claimed in claim 85 in which the result register is a bi-state device.

88. A parallel processing method of logic event simulation as claimed in claim 85 in which the result register comprises a D-flip flop.

89. A parallel processing method of logic event simulation as claimed in claim 87 in which the result register on start-up is supplied with an appropriate priming input instead of last result so that it is ready to receive the first result.

90. A parallel processing method of logic event simulation as claimed claim 85 in which the amended result registering mechanism further comprises a result polarity circuit to invert a result and ensure a logic 1 is applied to the result register if the correct response to a test was for the test to be failed.

91. A parallel processing method of logic event simulation as claimed in claim 90 in which the result polarity circuit comprises a pair of AND gates, a pair of inverters and an OR gate, a result polarity control is fed to each of the AND gates, the other input of each of the AND gates being provided by the result of a test carried out on a gate pair, the inverters inverting the two inputs to one of the AND gates, the outputs of the AND gates being fed directly to the OR gate.

92. A parallel processing method of logic event simulation as claimed in claim 85 in which the amended result registering mechanism is further provided with a logic combination circuit to determine whether an output gate pair of array 1b are ANDed or ORed together.

93. A parallel processing method of logic event simulation as claimed in claim 92 in which the logic combination circuit further comprises three AND gates and a logic combination circuit control, the logic combination circuit control being anded individually with each output of an array 1b gate pair and the gate pair anded in the third AND gate, when the logic combination requires an AND operation to be carried out, logic combination circuit control is given a value 0 and if an OR operation is required logic combination circuit control is given a logic value 1.

94. A parallel processing method of logic event simulation as claimed in claim 93 in which the logic combination circuit further comprises an OR gate, each of the outputs of the three AND gates being fed to the OR gate.

95. A parallel processing method of logic event simulation as claimed in claim 94 in which the output of the OR gate is led to the result polarity circuit as the result of a test carried out on a gate pair.

96. A parallel processing method of logic event simulation as claimed in claim 85 in which there is provided an amended result registering mechanism for each gate pair.

97. A parallel processing method of logic event simulation as claimed in claim 66 in which when all active segments have a state>S0, a check of all segment states is made until the lowest segment state Sₘᵢₙ is found, then each segment state is decremented by Sₘᵢₙ in order to advance simulation to the next evaluation stage.

98. A parallel processing method of logic event simulation as claimed in claim 97 in which the lowest state value is stored in a low global register and each time there is a gate state change if the new state is less than the low global state register value the low global register state value is replaced by the new state.

99. A parallel processing method of logic event simulation as claimed in claim 66 in which there is provided a scan system comprising a priority decoder and a shift register.

100. A parallel processing method of logic event simulation as claimed in claim 66 in which there is provided a segment address table and the segment address table is divided into a number of rows, each row being M bits long, and each segment address is stored in the most significant M-D bits of the segment row when the number of segments=2^{D}.

101. A processor for parallel processing of logic event simulation on circuits comprising a plurality of logic gates, the logic gates having interconnect lines therebetween, the processor further comprising a main processor and an associative memory mechanism, the associative memory mechanism comprising a plurality of associative arrays and at least one result register, characterised in that:
there is provided accessible external memory for storage of a circuit representation;
means to divide the circuit representation into a plurality of circuit segments;
means to allocate a circuit segment identifier to each circuit segment, each circuit segment identifier having circuit segment data associated therewith;
the associative memory mechanism comprising a segment table for storage of segment identifiers and segment data;
means to identify active segments in any one time interval based on the segment data; and
means to retrieve those active segments from external memory for evaluation by the associative memory mechanism.

102. A processor as claimed in claim 101 in which the segment data further comprises the maximum time delay for a gate in that segment to undergo a transition.

103. A processor as claimed in claim 101 in which the associative memory mechanism further comprises a pair of associative arrays (1a and 1b), an input value register and a hit list.

104. A processor as claimed in claim 103 in which cache data of associative array 1a and associative array 1b are stored in external memory during evaluation.

105. A processor as claimed in claim 101 in which after evaluation of the segment data the segments fan-out lists are updated.

106. A processor as claimed in claim 101 in which all interconnect lines are held in a segment dedicated to interconnect lines.

107. A processor as claimed in claim 101 in which all logic gates of a particular type are held in segments with logic gates of the same type.

108. A processor as claimed in claim 103 in which the segment table is an N_{S}×M bit segment table where Nₛ is equal to the number of segments and M is equal to the sum of all the number of bits width of associative array 1a, associative array 1b, input value register and the hit list.

109. A processor as claimed in claim 103 in which the set up time, T_{SETUP}, of synchronous devices may be modelled and in which T_{SETUP}=N.p+M, where N is equal to an integer, M is equal to an integer<P, and P is equal to the bit width of array 1b, in which:
the state entry in array 1a of this signal is set to S_{SN};
a start marker is placed in the left-most position of array 1b;
array 1b is incremented in the normal manner and when the start marker reaches the right-most position of array 1b and the signal has remained constant the state S_{SN} is decremented to S_{SN-1}, and the next time array 1b is incremented the start marker is returned to the left-most position in array 1b once again and the array 1b is then incremented in the normal manner;
the previous step is repeated until state entry=S_{S0}, then the array 1b is incremented another M times; and
if the signal has remained constant for N.p+M time units then the state entry in array 1a is set to state setup, S_{SETUP}.

110. A processor as claimed in claim 109 in which the hold time, T_{HOLD}, of synchronous devices may be modelled where T_{HOLD}=R.p+Q, and where R is an integer, Q is an integer<P and P is equal to the bit width of array 1b, in which:
when a clock makes a transition there is a search of state entries in array 1a to see if any input signals are in state S_{SETUP};
states in S_{SETUP} are updated to the state S_{HR}, and a start marker is placed in the left-most position of array 1b, array 1b is incremented in the normal manner until the start marker has made its way to the right-most position in array 1b and the signal has remained constant;
the state is decremented to S_{HR-1}, and the next time array 1b is incremented start marker is returned to the left-most position in array 1b, array 1b is then incremented in the normal manner and this is continued until the state is equal to S_{H0};
when S_{HR} equals S_{H0} then the array 1b is incremented a further Q times;
if signals remain constant over the entire period then the signal state is updated to S_{HOLD} and the output value of the device is ascertained.

111. A processor as claimed in claim 110 in which if the output value has changed, it is propagated to the fan-out list of the device.

112. A processor as claimed in claim 101 in which there is provided an amended result registering mechanism in which when a number of tests are carried out on the gate pair the result of each test is sent to a result register where on completion of all the test the result register output will indicate that all tests are successful or that at least one test was unsuccessful.

113. A processor as claimed in claim 112 in which the result register comprises an adder.

114. A processor as claimed in claim 112 in which the result register is a bi-state device.

115. A processor as claimed in claim 112 in which the result register comprises a D-flip flop.

116. A processor as claimed in claim 114 in which the result register on start-up is supplied with an appropriate priming input instead of last result so that it is ready to receive the first actual result.

117. A processor as claimed in claim 112 in which the amended result registering mechanism further comprises a result polarity circuit to invert a result and ensure logic 1 is applied to the result register if the correct response to a test was that a particular test on a gate pair was to be failed

118. A processor as claimed in claim 112 in which the amended result register mechanism is further provided with a logic combination circuit to determine whether an output gate pair of array 1b are ANDed or ORed together.

119. A processor as claimed in claim 118 in which logic combination circuit further comprises three AND gates and a logic combination circuit control, the logic circuit control being anded individually with each output of array 1b gate pair, and the gate pair ANDed in the third AND gate, when the logic combination requires an AND operation, logic combination circuit control is given a value 0 and when an OR operation is required logic combination circuit control is given a logic 1.

120. A processor as claimed in claim 119 in which the logic combination circuit further comprises an OR gate, each of the outputs of the three and gates being fed to the OR gate.

121. A processor as claimed in claim 120 in which the output of the OR gate is led to the result polarity circuit.

122. A processor as claimed in claim 101 in which when all active segments have a state>S0, a check of all segment states is made until the lowest segment state Sₘᵢₙ is found, then each segment state is decremented by Sₘᵢₙ in order to advance simulation to the next evaluation stage.

123. A processor as claimed in claim 122 in which the lowest state value is stored on a low global register and each time there is a gate state change if the new state is less than the low global state register value it replaces the low global state register value.

124. A processor as claimed in claim 101 in which there is provided a scan system comprising a priority decoder and a shift register.

125. A processor as claimed in claim 112 in which there is provided an amended result registering mechanism for each gate pair.

126. A processor as claimed in claim 101 in which there is provided a segment address table and the segment address table is divided into a number of rows, each row being M bits long, and each segment address is stored in the most significant M-D bits of the segment row when the number of segments is equal to 2^{D}.

127. A processor as claimed in claim 101 in which the processor is embodied in computer readable format.

128. A processor as claimed in claim 127 in which the processor in computer readable format may be stored on a disc.

129. A processor as claimed in claim 127 in which the processor in computer readable format may be stored on a record medium.

130. A processor as claimed in claim 127 in which the processor in computer readable format may be stored on a carrier wave.
